(19) United States
(12) Patent Application Publication
(10) Pub. No.: US 2024/0339624 A1
(43) Pub. Date: Oct. 10, 2024

(54) COMPOSITE LITHIUM-SODIUM ANODE FOR HIGH-PERFORMANCE SOLID-STATE BATTERIES AT LOW STACK PRESSURES

(71) Applicant: Georgia Tech Research Corporation, Atlanta, GA (US)

(72) Inventors: Matthew McDowell, Atlanta, GA (US); Sun Geun Yoon, Atlanta, GA (US)

(21) Appl. No.: 18/624,616

(22) Filed: Apr. 2, 2024

Related U.S. Application Data
(60) Provisional application No. 63/494,810, filed on Apr. 7, 2023.

(51) Int. Cl. H01M 4/62; H01M 4/02; H01M 4/134; H01M 4/38; H01M 10/0562

(52) U.S. Cl. CPC H01M 4/628; H01M 4/134; H01M 4/382; H01M 10/0562; H01M 2004/021; H01M 2004/027; H01M 2300/008

(57) ABSTRACT

An exemplary embodiment of the present disclosure provides an electrode for use with a solid state battery. The electrode can comprise a composite metal. The composite metal can comprise lithium (Li) and a mechanically soft filler.

### CROSS-REFERENCE TO RELATED APPLICATIONS

This application claims the benefit of U.S. Provisional Application Ser. No. 63/494,810, filed on 7 Apr. 2023, which is incorporated herein by reference in its entirety as if fully set forth below.

### GOVERNMENT LICENSE RIGHTS

This invention was made with government support under Agreement No. HR0011-22-2-0028, awarded by the Department of Defense (DARPA). The government has certain rights in the invention.

### FIELD OF THE DISCLOSURE

The various embodiments of the present disclosure relate generally to batteries, and more particularly to electrodes for solid-state batteries.

### BACKGROUND

Solid-state batteries are receiving increasing attention because of their potential for higher energy density/specific energy and improved safety compared to Li-ion batteries. However, a key aspect of the solid-state battery technology is the inclusion of a lithium metal-based anode due to its high specific capacity, and efforts to this end in recent years have been frustrated by the significant challenges associated with achieving reversible operation of lithium metal. Specifically, lithium metal has a tendency to grow as filaments through the solid-state separator during battery charge, which results in short circuits and battery death. Furthermore, during battery discharge, loss of contact at the lithium/solid-state electrolyte interface also causes major issues. Accordingly, there is a need for improved electrodes for solid-state batteries.

### BRIEF SUMMARY

An exemplary embodiment of the present disclosure provides an electrode for use with a solid state battery. The electrode can comprise a composite metal. The composite metal can comprise lithium (Li) and a mechanically soft filler.

In any of the embodiments disclosed herein, the mechanically soft filler can comprise sodium (Na).

In any of the embodiments disclosed herein, the sodium can be in the form of a plurality of particles dispersed within the lithium.

In any of the embodiments disclosed herein, sodium can be present in the electrode at an amount of no more than 25 at % Na.

In any of the embodiments disclosed herein, sodium can be present in the electrode at an amount of least 2.5 at % Na.

In any of the embodiments disclosed herein, the lithium and the mechanically soft filler can be immiscible in the temperature range of −20° C. to 60° C.

In any of the embodiments disclosed herein, the lithium and the mechanically soft filler may not form intermetallic compounds in compositions having between 1 atomic % filler and 50 atomic % filler.

In any of the embodiments disclosed herein, a ratio of a yield strength of the mechanically soft filler to a yield strength of the lithium can be less than or equal to 20:1.

Another embodiment of the present disclosure provides a solid-state battery, comprising a cathode, an anode, and at least one solid electrolyte positioned between the cathode and the anode. The anode can comprise a composite metal comprising lithium (Li) and a mechanically soft filler.

In any of the embodiments disclosed herein, the anode can have a Li stripping capacity of between 1 and 10 mAh cm⁻² at stack pressure ranges of 0-10 MPa.

In any of the embodiments disclosed herein, the anode can retain an overpotential of less than 0.1 V in a half cell when stripping up to 11 mAh cm⁻² and the solid-state battery is at stack pressures less than 2.5 MPa.

In any of the embodiments disclosed herein, the solid electrolyte can comprise a sulfide-based material, such as Li₆PS₅Cl (LPSC), an oxide material, or a polymer material.

In any of the embodiments disclosed herein, the battery can retain at least 80% of its initial charge capacity over 100 cycles at a stack pressure of less than 2.5 MPa.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIGS. 1A-B provide schematics of a composite electrode and a solid-state battery employing a composite electrode, respectively, in accordance with some embodiments of the present disclosure.

FIGS. 2A-D provide Cryo-focused ion beam (FIB) scanning electron microscopy (SEM) images of lithium-sodium composites with (FIG. 2A) 2.5 at. % Na, (FIG. 2B) 5 at. % Na, (FIG. 2C) 10 at. % Na, and (FIG. 2D) 20 at. % Na, in accordance with some embodiments of the present disclosure. FIG. 2E provides a schematic image of pristine Li-solid electrolyte (SE) interface, showing the presence of voids and dendritic lithium deposition. FIGS. 2F-G provide schematic images of Li/Na composite-SE interfaces during (FIG. 2F) Li stripping and (FIG. 2G) plating steps.

FIG. 3A provides a plot of voltage profiles during stripping of Li from Li/Na composite electrodes, in accordance with some embodiments of the present disclosure, at various Na concentrations and stack pressures, in which the cells were fabricated with a Li counter electrode and tested at 0.25 mA cm⁻² at the stack pressures noted in the figure. FIG. 3B provides a plot of depletion time (t₀^{-1/2})-current density (i) dependence for evaluating interfacial Li supplement capabilities, in which the extracted Li transport descriptors are tabulated. FIG. 3C provides a plot of Li stripping capacities as a function of stack pressure at different Na concentrations, in which the areal capacities for Li depletion were determined at the cutoff voltage of 0.15 V.

FIGS. 4A-C provide in situ electrochemical impedance spectroscopy (EIS) analysis of (FIG. 4A) pure Li, (FIG. 4B) 2.5 at. % Na, and (FIG. 4C) 10 at. % Na electrodes, undergoing Li stripping up to 5 mAh cm⁻², in accordance with some embodiments of the present disclosure, in which galvanostatic voltage profiles during stripping are shown in the left panel of each figure, potentiostatic EIS spectra were collected periodically every 0.5 mAh cm⁻² capacity, vertical lines in the voltage profiles denote the points where the EIS was implemented, and the corresponding Nyquist plots at each areal capacity are shown in the right panel of each figure.

FIG. 4D provides Nyquist plots of Na symmetric cells with a Li ion conducting solid electrolyte (Li₆PS₅Cl).

FIGS. 5A-B provide plots of electrochemical cycling tests of the 5 at. % Na composite and pure Li electrodes at (FIG. 5A) a current density of 0.75 mA cm⁻² and a stack pressure of 2.5 MPa, and (FIG. 5B) a current density of 1 mA cm⁻² and a stack pressure of 4.1 MPa, in which the composite electrodes were paired with Li₁In₃ counter electrodes (E=0.62 V vs. Li/Li⁺) and cycled with an areal capacity of 2 mAh cm⁻². FIGS. 5C-D provide plots of electrochemical cycling tests of the 10 at. % Na composite anode paired with an NMC cathode at (FIG. 5C) 0.5 mA cm⁻² and (FIG. 5D) 0.75 mA cm⁻² current densities. The cells were operated with 0.8 MPa stack pressure. FIG. 5E provides a plot of capacity retention and Coulombic efficiencies (CEs, retrieved Li capacity divided by plated Li capacity), in which composite anodes with a thickness of ˜90 μm were used in the cells.

FIGS. 6A-C provide cryogenic focused ion beam (Cryo-FIB) scanning electron microscopy (SEM) images of an exemplary Li/Na composite anode (10 at. % Na) at the solid electrolyte interface, wherein the composite electrodes are in the following states: (FIG. 6A) pristine, (FIG. 6B) after 4 mAh cm⁻² Li stripped, and (FIG. 6C) after 4 mAh cm⁻² Li stripped and then 2 mAh cm⁻² Li plated.

FIG. 7A provides a schematic image of exemplary constructed cells for testing of Na and Cu foils as working electrodes, wherein Li or NMC622 were used as counter electrodes and Na and Cu foils were 27 μm and 10-15 μm thick, respectively. FIG. 7B provides plots of electrochemical cycling tests with Na (top) and Cu (middle) foils as working electrodes along with their initial Li plating voltage profiles (bottom). FIG. 7C provides a plot of coulombic efficiencies (CEs) of the Na and Cu half-cell cycling tests shown in FIG. 7B, in which both cells were cycled with 0.25 mA cm⁻² and 1 mAh cm⁻² per cycle at 3.2 MPa stack pressure. FIG. 7D provides plots of 2nd charging/discharging profiles and FIG. 7E provides plots of discharge capacities and coulombic efficiencies (CEs), of exemplary Na∥NMC and Cu∥NMC cells at 0.25 mA cm⁻² current density and 4.9 MPa stack pressure.

FIG. 8 provides stack pressure-current density plot for various electrodes, wherein the Li/Na composite dots represent the electrochemical cycling results shown in FIGS. 5A-D and all other data points are for conventional electrodes and based on data available in the literature.

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

Embodiments of the present disclosure provide composite electrodes that show high performance in solid-state batteries at low stack pressures. The composite electrodes can comprise sodium metal (or another soft filler) mixed with lithium metal in small concentrations (e.g., 2-25 atomic percent). It is shown that the composite metal is extremely soft (softer than pure lithium), which is beneficial for interfacial contact. Furthermore, the inclusion of the soft filler (e.g., sodium) allows for significantly enhanced cycling stability compared to pure lithium at low stack pressures (e.g., 10 MPa and below), which can be desirable for commercial solid-state batteries. The battery electrodes disclosed herein can be directly integrated into solid-state batteries of a variety of chemistries.

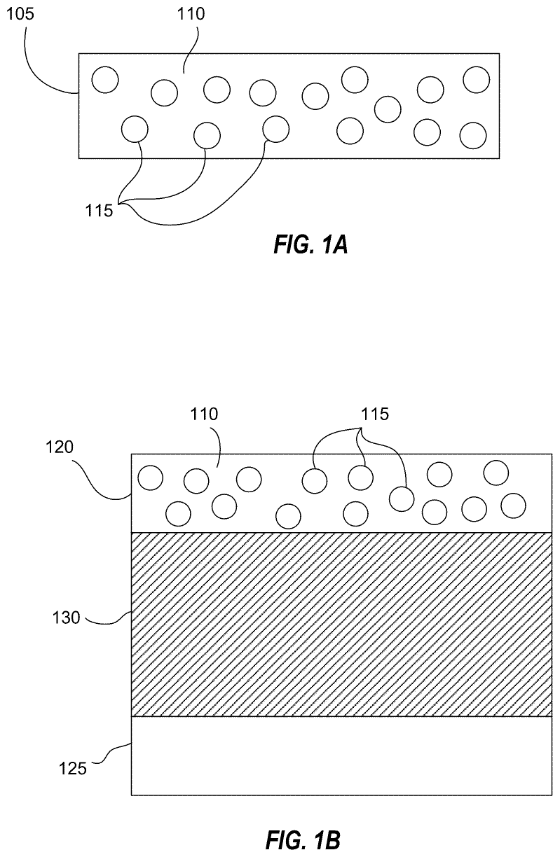

As shown in FIG. 1A, and exemplary embodiment of the present disclosure provides an electrode 105 for use with a solid state battery. The electrode 105 can comprise a composite metal. In some embodiments, the composite metal can comprise lithium (Li) 110 and a filler 115.

In some embodiments, the filler 115 can be a mechanically soft filler. As used herein, “mechanically soft” means that the filler 115 has a yield strength of between 0.1 MPa and 20 MPa. In some embodiments, the filler 115 can have a yield strength of less than 15 MPa, less than 10 MPa, less than 5 MPa, less than 4 MPa, less than 3 MPa, less than 2 MPa, less than 1 MPa, less than 0.8 MPa, less than 0.7 MPa, less than 0.6 MPa, or less than 0.5 MPa. In some embodiments, the filler 115 can have a yield strength that is less than other components of the composite metal, e.g., lithium. In some embodiments, a ratio of a yield strength of the filler 115 to a yield strength of the lithium 110 can be less than or equal to 20:1, 15:1, 10:1, 9:1, 8:1, 7:1, 6:1, 5:1, 4:1, 3:1, 2:1, or 1.5:1, in accordance with various embodiments of the present disclosure.

In some embodiments, the filler 115 can comprise sodium (Na). The disclosure, however, is not so limited. In some embodiments, the filler 115 can be elements or compounds other than sodium. Additionally, in some embodiments, the filler 115 can comprise multiple elements and/or compounds.

In any of the embodiments disclosed herein, as shown in FIG. 1A, the filler 115 can be in the form of a plurality of particles dispersed within the lithium 110. The particles can have many different sizes in accordance with various embodiments of the present disclosure. For example, in any of the embodiments disclosed herein, the plurality of particles can have an average or maximum length of no more than 100 microns, 50 microns, 40 microns, 30 microns, 20 microns, or 10 microns. Additionally, in any of the embodiments disclosed herein, the plurality of particles can have an average or maximum length of at least 1 micron, 2 microns, 3 microns, 4, microns, 5 microns, or 10 microns. Additionally, as those skilled in the art would understand, in any of the embodiments disclosed herein, the plurality of particles can have an average or maximum length encompassing a range of sizes from any of the above, e.g., 10-40 microns, 3-30 microns, 1-100 microns, etc.

The filler 115 can be present in the electrode 105 at many different amounts, in accordance with various embodiments of the present disclosure. In some embodiments, the filler 115 can be present in the electrode 105 at an amount of at least 1 at % filler (e.g., 1 at % Na), 2 at %, 3 at %, 4 at %, 5 at %, 10 at %, 15 at %, 20 at %, 25 at %, 30 at %, 35 at %, 40 at %, 45 at %, or 50 at %. Additionally, in some embodiments, the filler can be present in the electrode at no more than 50 at %, 45 at %, 40 at %, 35 at %, 30 at %, 25 at %, 20 at %, 15 at %, 10 at %, 5 at %, 4 at %, 3 at %, 2 at %, or 1 at %. Additionally, as those skilled in the art would understand, in any of the embodiments disclosed herein, the filler 115 can be present in the electrode at range of sizes from any of the above, e.g., 1-25 at % filler (e.g., Na), 3-35 at %, 10-45 at %, etc.

In any of the embodiments disclosed herein, the lithium 110 and the filler 115 can be immiscible. In some embodiments, the lithium 100 and the filler 115 can be immiscible over varying temperature ranges, including at least −100° C., −80° C., −60° C., −40° C., −20° C., −10° C., 0° C., 10° C., 20° C., 40° C., 60° C., 80° C., 100° C., and/or no more than 100° C., 80° C., 60° C., 40° C., 20° C., 10° C., 0° C., −10° C., −20° C., −40° C., −60° C., −80° C., or −100° C. As those skilled in the art would understand, the lithium 110 and filler 115 can be immiscible over varying temperature ranges from the above values, e.g., −80° C. to 20° C., −20° C. to 60° C., 0° C. to 100° C., etc.

In any of the embodiments disclosed herein, the lithium 110 and the filler 115 may not form intermetallic compounds in compositions having at least 1 atomic % filler and no more than 50 atomic % filler, no more than 45 atomic % filler, no more than 40 atomic % filler, no more than 35 atomic % filler, no more than 30 atomic % filler, no more than 25 atomic % filler, no more than 20 atomic % filler, no more than 15 atomic % filler, no more than 10 atomic % filler, or no more than 5 atomic % filler.

When used in solid state batteries, the electrodes 105 disclosed herein can achieve improved stripping capacities at low stack pressures (e.g., less than 10 Mpa) over the prior art. In some embodiments, the electrodes can have a Li stripping capacity of between 1 and 10 mAh cm⁻².

As discussed above, the electrodes 105 disclosed herein can be used to improve the performance of solid state batteries. Accordingly, as shown in FIG. 1B, some embodiments of the present disclosure provide solid-state batteries, comprising an anode 120, a cathode 125, and at least one solid electrolyte 130 positioned between the cathode 125 and the anode 120. In some embodiments, the anode can comprise the electrodes 105 disclosed above having a composite metal comprising lithium (Li) 110 and a filler 115.

The solid electrolyte 130 can be many different solid electrolytes known in the art. In some embodiments, the solid electrolyte 130 can comprise a sulfide based material, including, but not limited to Li₆PS₅Cl (LPSC). In some embodiments, the solid electrolyte 130 can comprise an oxide material. In some embodiments, the solid electrolyte 130 can comprise a polymer material.

The electrodes 105 disclosed herein provide many performance advantages over conventional electrodes when employed in solid state batteries. For example, in some embodiments, the anode can retain an overpotential of less than 0.1V in a half cell when stripping up to 11 mAh cm⁻² and the solid-state battery is at stack pressures less than 2.5 MPa. Similarly, in some embodiments disclosed herein, the battery can retain at least 80% of its initial charge capacity over 100 cycles at a stack pressure of less than 2.5 MPa.

In the experimental section below, many examples and testing results are disclosed. This section is provided solely for purposes of explaining how certain embodiments of the present disclosure can be made and how they can perform. This section, however, should not be construed to limit the scope of the present disclosure of the claims included herewith.

### Experimental Section

### Lithium/Sodium (Li/Na) Composite and Lithium-Indium (LiIn) Alloy Foils Fabrication

Li/Na composite working electrodes were fabricated using an accumulative roll bonding process. A Li|Na|Li stacked foil was folded and calendared repeatedly until the phases were sufficiently mixed. The final thickness of the foil was controlled with the calendaring process. The Na atomic ratio was controlled by adjusting the mass of Na and Li foils prior to stacking. The same method was used to preparing LiIn alloy films for use as counter electrodes for electrochemical testing. The Li: In atomic ratio was controlled before the initial In|Li|In stack, and a 1:3 (Li: In) ratio was used in the tests.

LiNi_{0.6}Mn_{0.2}Co_{0.2}O₂ (NMC) composite fabrication

The LiNi_{0.6}Mn_{0.2}Co_{0.2}O₂ (NMC) composite mixture was prepared for the cathode in full cell tests. Single crystral NMC (particle size: 3-6 μm) powder was coated with LiNb_{0.5}Ta_{0.5}O₃ (LNTO). The LNTO-coated NMC powder was mixed with vapor grown carbon fiber (VGCF, Sigma Aldrich) and Li₆PS₅Cl (LPSC, ˜1 μm particle size) (mass ratio of 70:27.5:2.5 in NMC:LPSC:VGCF) in a planetary ball mill (Fritsch Pulverisette 7) at 150 rpm for an hour.

### Cell Assembly and Electrochemical Testing

90 mg of the LPSC (˜10 μm particle size) solid electrolyte (SE) powder was poured into a polyether ether ketone (PEEK) die, which has an inner diameter of 10 mm, and pressed uniaxially at 440 MPa for 5 min. The thickness of the pressed pellets was typically 650-700 μm. Li foil served as a counter-electrode in the electrochemical Li stripping tests. Li metal disks and the composite foils were punched out and attached to titanium plungers. The plungers were inserted into both ends of the PEEK die. To form interfacial contact, the Li/Na foil|LPSC|Li stack was vertically pressed with a pressure of 60 MPa for 5 min. The mass of Li disk was 11-13 mg (corresponding to a thickness of 260-320 μm). The mass of the composite disk was kept within 6-8 mg which corresponded to a thickness of 100-150 μm.

For electrochemical cycling tests, Li₁In₃ alloy foils were used as a counter electrode instead of pure lithium. Punched Li₁In₃ disks were inserted into PEEK dies with a titanium plunger. The Li/Na foil|LPSC|LiIn stack was uniaxially pressed in the same manner as described above. The thickness of Li₁In₃ disk was ˜ 140 μm.

For the half-cell tests with Na or Cu foil electrodes, the cells were built with Na or Cu disks as a working electrode and the Li disk as a counter-electrode. Na and Cu disks were 28 μm and 10 μm thick, respectively, and they were inserted into one side of the PEEK dies using titanium plungers. Sandwiched Na|LPSC|Li stacks were uniaxially pressed at 60 MPa pressure for 5 min. The same pressing conditions were applied to Cu|LPSC|Li stacks, and prior to pressing, Cu|LPSC stacks were uniaxially pressed for a few seconds with 375 MPa to make conformal contact at their interface.

The NMC composite mixture was served as a cathode in the full cell tests. The poured SE powder was uniaxially compressed with 120 MPa pressure for 1 min, and the NMC composite powder was added on the loosely pelletized SE. The NMC composite poured pellet was pressed again with 440 MPa for 5 min. Li/Na composite or Na foils were attached on the other side of the pellet and uniaxially pressed with 60 MPa for 5 min to form an interfacial contact. Pressed cells were sandwiched between two steel plates, and the stack pressure applied during electrochemical cycling was controlled by using a torque wrench to tighten four bolts and nuts at each corner.

Electrochemical impedance spectroscopy (EIS) measurement was carried out with a Bio-Logic SP-200 potentiostat between 2 MHz and 0.2 Hz frequencies. Impedance spectra were measured during the galvanostatic Li stripping up to 5 mAh cm⁻² capacity after every 0.5 mAh cm⁻² capacity was stripped from the working electrode. All electrochemical tests were carried out at room temperature (25° C.) in an Ar-filled glove box atmosphere.

### Cryo-FIB SEM Imaging

Cryogenic focused ion beam (cryo-FIB) scanning electron microscopy (SEM) was conducted using a Thermo Fisher Helios 5CX FIB-SEM equipped with a Ga ion source and Quorum cryogenic stage system. The composite anode|LPSC|Li cell was built in the same manner as the cell used in the Li stripping test. A representative anode of Na 10 at. % was used for imaging the interface. Samples were extracted from cells and rapidly transferred into the vacuum chamber, with a few seconds of air exposure. Samples were cooled down to −140° C. prior to the ion beam etching to reduce detrimental interactions with the ion beam. The first milling cuts were performed using an ion accelerating voltage of 30 kV and beam current of 65 nA. The final polishing was made at 30 kV and 2.8 nA. Images were captured using an Everhart-Thornley secondary electron detector with an accelerating voltage of 5 kV and current of 0.34 nA.

The accumulative roll bonding method was used for Li/Na composite film fabrication. Folding and calendaring of the Li|Na|Li stacked foil repeatedly produced composites with Na particles with size of a few microns to tens of microns within a Li matrix, as shown in FIG. 1.

### Li/Na Composite Electrode and Mechanistic Benefits of the Na Phase During the Evolution of the Composite Electrode

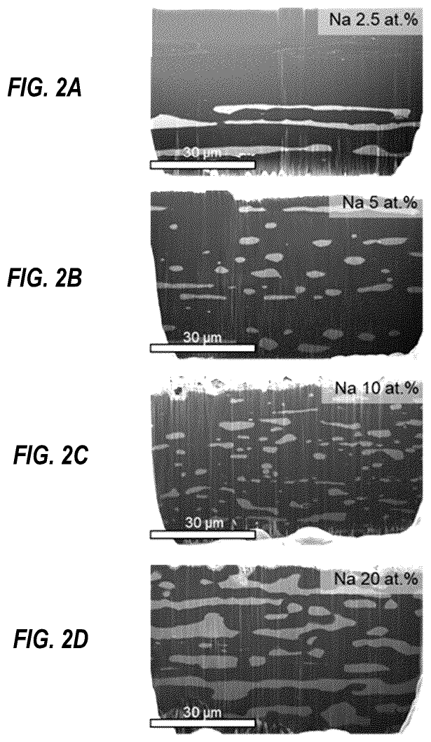

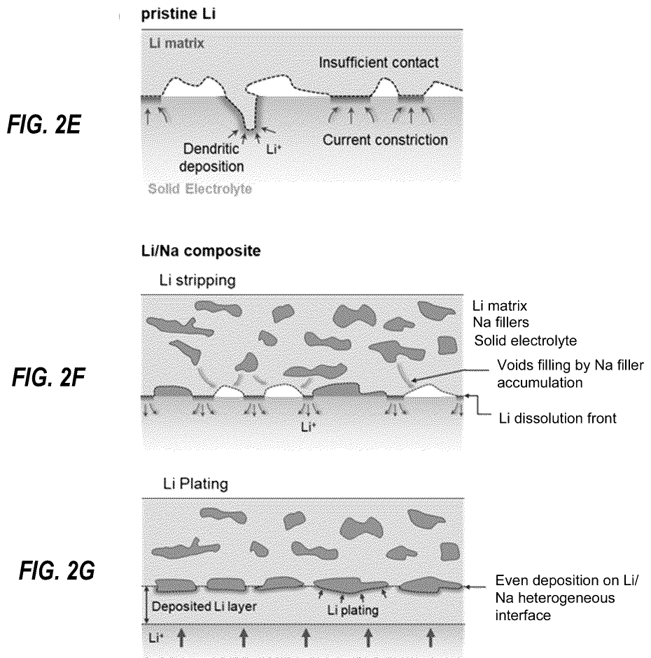

Li/Na composite foils can be fabricated by iteratively folding and calendaring of the Li|Na|Li stacked foils. The produced composite foils can have the Na phase distributed in the Li matrix with domain size of a few microns to tens of microns, as shown in FIGS. 2A-D. The pristine Li metal electrode suffers from morphological instability at the solid electrolyte interface during electrochemical cycling due to poor contact and fracture of the solid electrolyte via dendritic deposition (FIG. 2E). Na has lower yield strength and elastic modulus than Li metal, and it forms a composite with Li with negligible miscibility. Due to these properties, incorporating the secondary Na phase into Li metal can impart an increase of mechanical deformability to the electrode. This benefit not only boosts conformity to the solid electrolyte interface during cell fabrication, but can also be advantageous during the electrochemical cycling process, promoting sodium accumulation during lithium stripping and therefore mitigating void formation (FIGS. 2F-G).

### Li Stripping Behavior

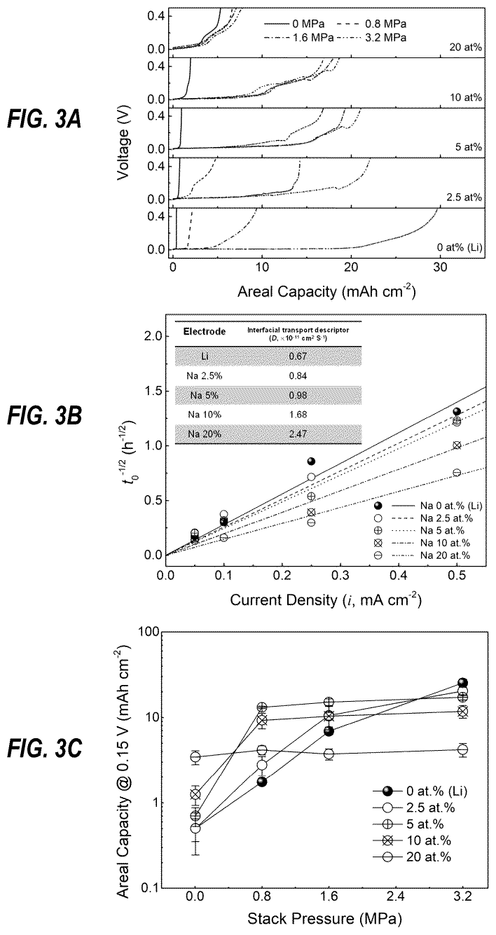

Voltage profiles during the Li stripping process were investigated using Li/Na composite working electrodes to evaluate polarization behavior (FIGS. 3A-B). Stack pressures from 0 to 3.2 MPa were applied, and Li was electrochemically stripped from the composite electrode and deposited at the Li metal counter electrode using a current density of 0.25 mA cm⁻². This pressure range is relatively low in the context of published literature. A pure Li working electrode, which has a similar mass to the Li/Na composite anode (6-8 mg), was tested as a control experiment (FIG. 3A). The pure Li electrode was able to strip 29.7 mAh cm⁻² at 3.2 MPa before reaching the 0.5 V cutoff voltage. However, the stripping capacity was substantially reduced when lowering the stack pressure, and only 0.52 mAh cm⁻² of Li was stripped at 0 MPa stack pressure. Lithium stripping causes void formation at the Li/SE interface at low stack pressure (FIG. 2E), which results in loss of interfacial contact and impedance growth. This indicates the need for mechanical pressure to control the Li/SE interface for stable Li utilization when using pure Li electrodes. In contrast, the Li/Na composite anodes showed higher and more consistent stripping capacities independent of the stack pressure. In the electrodes with 5 and 10 at. % Na, similar stripping capacities between 17 and 21 mAh cm⁻² were observed at applied stack pressures of 0.8-3.2 MPa (FIG. 3A). The 20 at. % Na composite exhibited stripping capacities of about 5 mAh cm⁻² regardless of the applied stack pressure. FIG. 3B provides a clearer illustration of these trends by showing how the stripped capacities relate to the applied stack pressure. The voltage profiles of the composite electrodes in FIG. 3A commonly showed kink regions near 0.15-0.2 V, which could be due to oxidization of Na. Thus, a cutoff voltage of 0.15 V was used to determine the Li stripping capacities for FIG. 3B without the influence of Na side reactions. For pure Li or 2.5 at. % Na, the stripping capacities increased in proportion to the applied pressure, indicating that interfacial Li transport is dependent on the pressure applied to the cell stack. On the other hand, at higher Na concentrations (5-20 at. % Na), the stripping capacities of the composite electrodes became saturated at certain values and independent of the stack pressure. A noteworthy point is that the higher Na concentration composites exhibited greater stripping capacities than the pristine Li at pressures less than 1.6 MPa, indicating their capabilities of boosting stripping performance at low stack pressures.

One of the primary reasons for this advantage is likely due to the mechanical properties of the Li/Na composite. Compared to Li metal, Na metal is softer and malleable. Li metal has generally been reported to have higher elastic moduli (Li: 7.82 GPa and Na: 4.6 GPa) and a higher yield strength (Li: 0.73-0.81 MPa and Na: 0.19-0.28 MPa) than Na metal. Because of these characteristics, the Li/Na composite foils have lower elastic moduli than pure Li. These moduli also can be decreased as the portion of Na in the Li matrix increases. This could result in a better physical conformity with the SE interface under the lower stack pressure. In addition, the composite electrode/solid electrolyte interfacial contact can be retained instead of the forming voids during the electrochemical Li stripping process. This is because the Na material can be accumulated at the interface during striping instead of forming voids because of its inertness near the Li redox potential (FIG. 1f). To understand this effect, the capability of the composite electrode to transport Li to the interface was evaluated, as shown in FIG. 3B. It is assumed that Li stripping from the working electrode can cause Li depletion near the solid electrolyte interface, thereby inducing Li transport from the bulk to the interface. Based on this assumption, the depletion time (to) was measured at different current densities (i) in the absence of the stack pressure in order to exclude the mechanical effect, and the Li transport capability (D) of the composite electrodes was estimated based on Sand's equation as follows.

$$\frac{1}{\sqrt{{t}_{0}}} = \frac{2}{{c}_{0} F \sqrt{D π}} i$$

Herein, c₀ and F are the initial Li concentration in the composite electrode and Faraday's constant, respectively. t₀ was adopted as the time reaching at the 0.15 V cutoff voltage. FIG. 3B shows a t₀^{-1/2} to i relation under different Na concentrations, and the D from each condition was estimated as shown in the table of FIG. 3C. The Li transport capability (D) increased when the Na concentration was increased, with the 20 at. % Na composite exhibited a D of 2.47×10⁻¹¹ cm² s⁻¹, more than three times that of the pristine Li (0.67×10⁻¹¹ cm² s⁻¹). The accumulation of the incorporated Na phase at the solid electrolyte interface can reduce the tendency for void formation with improving the morphological stability of the interface. The increased Li transport capability by incorporating the Na materials demonstrates that this can possibly suppress the interfacial Li depletion, thereby boosting the effective Li transport even without the assistance of mechanical pressure in the Li dissolution process.

### Na Filler Behaviors at the SE Interface

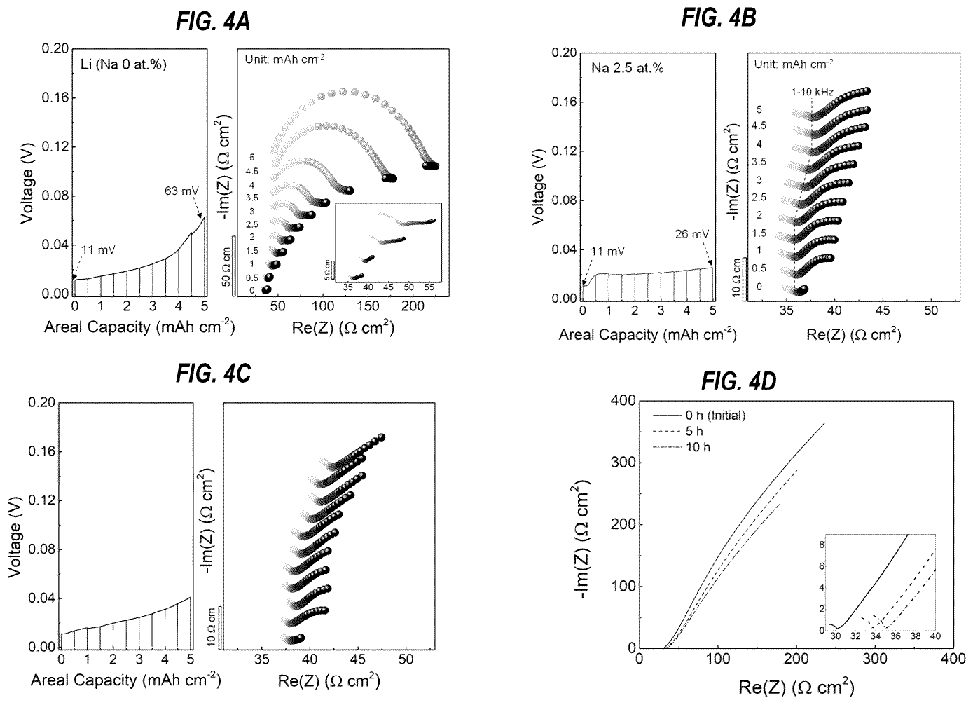

Electrochemical impedance spectroscopy (EIS) was carried out to investigate the interfacial behavior of the Na/Li composite electrodes (FIGS. 4A-C). Li was stripped from three different electrodes to a capacity limit of 5 mAh cm⁻² using 0.25 mA cm⁻² current density. The three electrodes were pure Li, 2.5 at. % Na, and 10 at. % Na, all using 1.6 MPa stack pressure. Lithium metal was used as the counter electrode in all cases. EIS was conducted periodically at 0.5 mAh cm⁻² capacity increments during the Li stripping. The pure Li electrode exhibited the greatest voltage increase from 11 to 63 mV, whereas the 2.5 and 10 at. % Na electrodes showed voltage increases from 11 to 26 mV and 11 to 41 mV, respectively. All cells initially presented partial semicircles touching the x-axis at relatively low impedance (35-40Ω cm²) in the Nyquist plots, which corresponds to interfacial impedance. During stripping, the pure Li exhibited growth of the size of the semicircle up to ˜220Ω cm² (FIG. 4A). In contrast, the semicircle widths of the composite electrodes (2.5 and 10 at. % Na) remained constant near 35-40Ω cm² during identical stripping processes. The growth of the semicircle and the corresponding increase of interfacial impedance for pure Li can be attributed to interfacial contact loss at the working electrode-solid electrolyte interface. The pronounced impedance increase in the pristine Li suggests substantial contact loss during stripping (FIG. 2E), which could be due to insufficient stack pressure to suppress formation of interfacial voids. On the other hand, the composite electrodes retained their interfacial contact without increased interfacial resistance. Both composite electrodes also featured the growth of sloping tails in the low frequency region (<1 kHz). The low frequency tails became closer to straight slopes as the stripping capacity increased. As shown in FIG. 4D, a Nyquist plot of a Na symmetric cell with the Li ion conducting electrolyte (Li₆PS₅Cl) exhibited straight sloping lines, indicating Li ion blocking behavior of Na contacting the solid electrolyte interface. Therefore, the growth of these tails during Li stripping from the composite electrodes arises due to the accumulation of Na at the interface. This behavior was more prominent at higher Na concentration (10 at. % Na, FIG. 4C) due to higher Na content. These findings verify that the Na accumulation instead of void formation can result in a morphologically stable interface, thereby sustaining connections between the Li reservoir in the composite electrode and the SE during the electrochemical Li dissolution process. This process is highly effective even at low stack pressures, as compared to the pure Li which requires substantial stack pressure to retain the same stability.

### Electrochemical Cycling Performance of Li/Na Composite Electrode

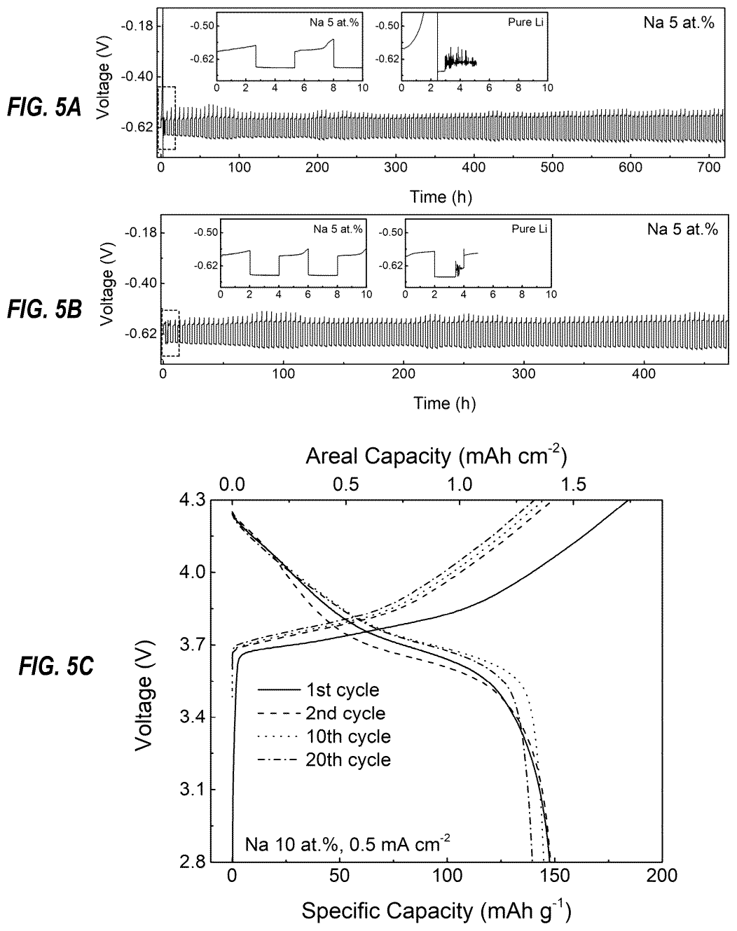

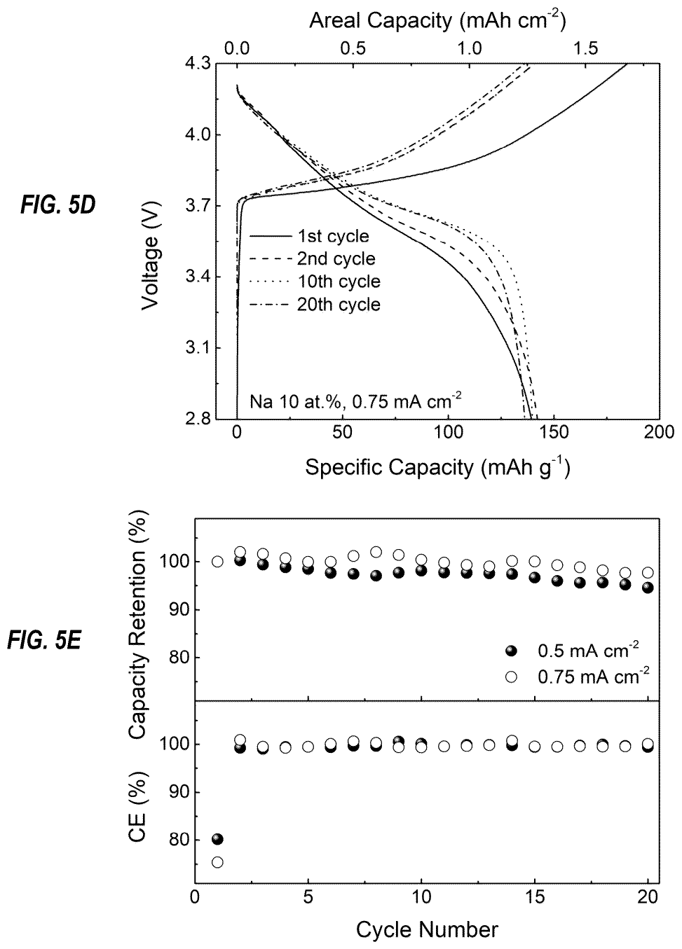

Electrochemical cycling performance of the composite electrodes was evaluated using Li₁In₃ alloy counter electrodes (FIGS. 5A-B). As previously discussed, the pristine Li-SE interface has voiding issues which can deteriorate the reversible cycling performance. This can also happen when a Li foil is used as a counter electrode, which can interfere with observing the actual electrochemical reversibility of the working electrode. The Li₁In₃ counter electrode can reduce this type of interference, and it was thus used here. The electrochemical cycling tests were conducted with the 5 at. % Na composite anode using an areal capacity per cycle of 2 mAh cm⁻². Since the redox potential of the Li₁In₃ alloy is +0.62 V (vs. Li/Li⁺), all electrochemical cycling data obtained using Li₁In₃ counter-electrode was centered around-0.62 V. The voltage profiles above −0.62 V in FIGS. 5A-B represent the Li stripping process, while the voltage profiles below −0.62 V represent the Li plating process. FIG. 5A shows the cell cycling using 0.75 mA cm⁻² at a relatively low stack pressure of 2.5 MPa. The composite anode maintained stable stripping voltages over 100 cycles. When the current density was increased to 1 mA cm⁻², the composite anode was able to cycle favorably at 4.1 MPa of stack pressure. This is still considerably lower compared to a critical stack pressure required to operate pure Li with a current density of 1 mA cm⁻² (7 MPa)^{[7]}. As a control experiment, a pure Li metal anode was tested using these conditions (red voltage profiles in FIGS. 5A-B). The voltage profile began with Li stripping from the anode side and commonly showed short-circuits during the subsequent plating steps. This was caused by the dendritic deposition on the Li metal working electrode, which originated from the interfacial voiding effect in the previous Li stripping step (FIG. 1c). On the contrary, the high reversibility in the composite electrode cycling demonstrates the beneficial influence of Na for increasing the morphological stability and contact at the interface.

The composite anodes were evaluated in full cells paired with NMC composite cathodes. Details of the NMC composite preparation and its full cell fabrication are described in the experimental section. The 10 at. % Na composites were assembled with the NMC cathode and operated at 0.8 MPa stack pressure, and the cells were cycled in a voltage range of 2.8-4.3 V with current densities of 0.5 and 0.75 mA cm⁻² (FIGS. 5C-D). This stack pressure is extremely low as compared to previous literature. Higher stack pressure conditions, such as a few to a few tens of MPa, are often used in experiments to improve the interfacial instability of solid-state batteries, but such stack pressures are impractical for commercial applications due to the requirement of massive cell housings for maintaining such pressures. FIGS. 5C-D show voltage-capacity profiles at both current densities. Since the NMC cathode initially contains Li, the cell cycling was begun by charging first, which corresponds to Li plating on the composite anode. The charging profiles were stable without any short circuiting despite the relatively high current density and low stack pressure. The cells exhibited specific capacities of 184 mAh g⁻¹ (1.74 mAh cm⁻²) and 185 mAh g⁻¹ (1.68 mAh cm⁻²) at 0.5 and 0.75 mA cm⁻², respectively. During the first discharging, 148 mAh g⁻¹ (1.39 mAh cm⁻²) and 139 mAh g⁻¹ (1.27 mAh cm⁻²) were observed at 0.5 and 0.75 mA cm⁻² current densities, respectively. During extended cycling, the cells showed hysteresis in the discharge profiles. After charging the cells, the composite anode could be isolated from the SE interface by the Li deposition on it, which is likely to form voids and impose additional polarization in the subsequent discharging step (Li stripping). The voltage hysteresis in the discharge profiles were larger at the current density of 0.75 mA cm⁻², indicating that the higher current density causes a greater tendency to form interfacial voids during the Li dissolution step. However, as compared to the 1st or 2nd cycles, the discharging profiles at the 10th and 20th cycles showed the overpotential decreases at both current densities. This could be due to stabilization of the interface with the Na material with cycling, suggesting that the composite anode is effective independent of the cycling modes. Upon further cycling, the cells retained their capacities over 95% after 20 cycles along with high Coulombic efficiencies (CE) above 99.5% (FIG. 5E).

### Cryo FIB SEM Imaging

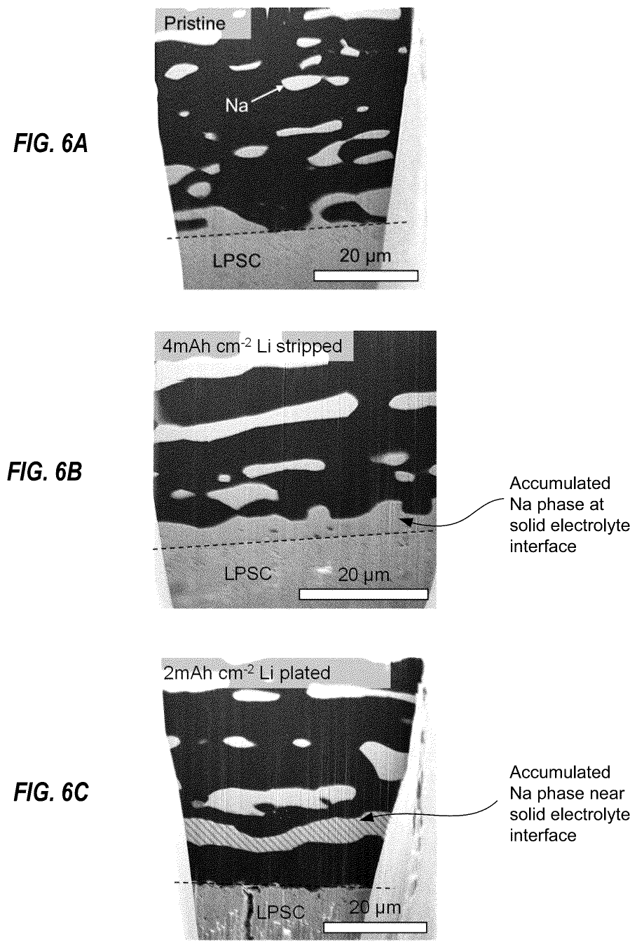

Cryo-focused ion beam (FIB) milling and SEM imaging was carried out with a composite electrode featuring 10 at. % Na to reveal the morphological evolution of the composite at the SE interface. Composite anode|LPSC|Li cells were built and electrochemically cycled using a current density of 0.25 mA cm⁻² and a stack pressure of 1.6 MPa. The cycled cell was extracted from the PEEK die and transferred to an SEM instrument. FIGS. 6A-C show the cross-sectional images of the composite anode-SE interface in the pristine state (FIG. 6A), after 4 mAh cm⁻² of Li was stripped (FIG. 6B), and after 4 mAh cm⁻² of Li was stripped and then 2 mAh cm⁻² of Li was redeposited (FIG. 6C). Each sample was cross sectioned with the FIB beam under a temperature of −140° C., preserving the interfacial state with minimal ion beam damage. The pristine sample (FIG. 6A) shows the lighter Na phase distributed throughout the darker Li matrix. The gray and homogeneous region below the composite anode is the Li₆PS₅Cl layer (labeled LPSC). In FIG. 6B, the Na is seen to accumulate at the anode-SE interface after Li was stripped from the composite (the accumulated Na phase is highlighted as an oblique pattern in FIG. 6B), which is consistent with the EIS result shown in FIG. 4C. The image shows that the Na phase filled the gaps between the Li phase and the SE, creating a seamless interface. After Li was plated on that interface (FIG. 6C), a uniform and dense Li layer was formed while the accumulated Na layer (oblique pattern) receded toward the interior of the electrode. Simultaneously, there was no observed filamentary Li penetration toward the SE layer. These findings were consistent with the electrochemical Li stripping and cycling tests shown in FIGS. 5A-E.

### Na and Cu Half-Cell and Anode-Free Cell Tests

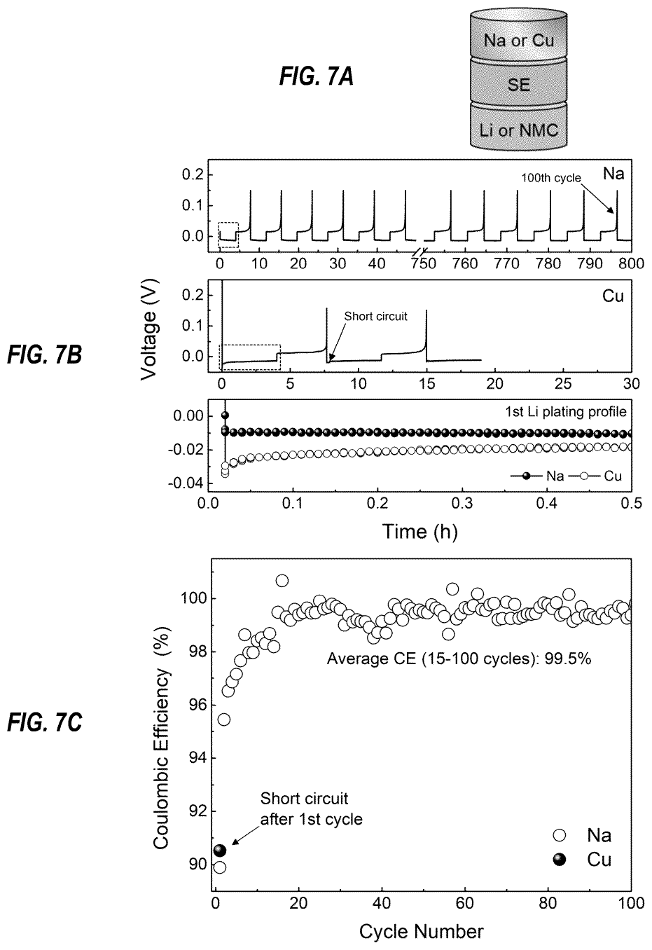

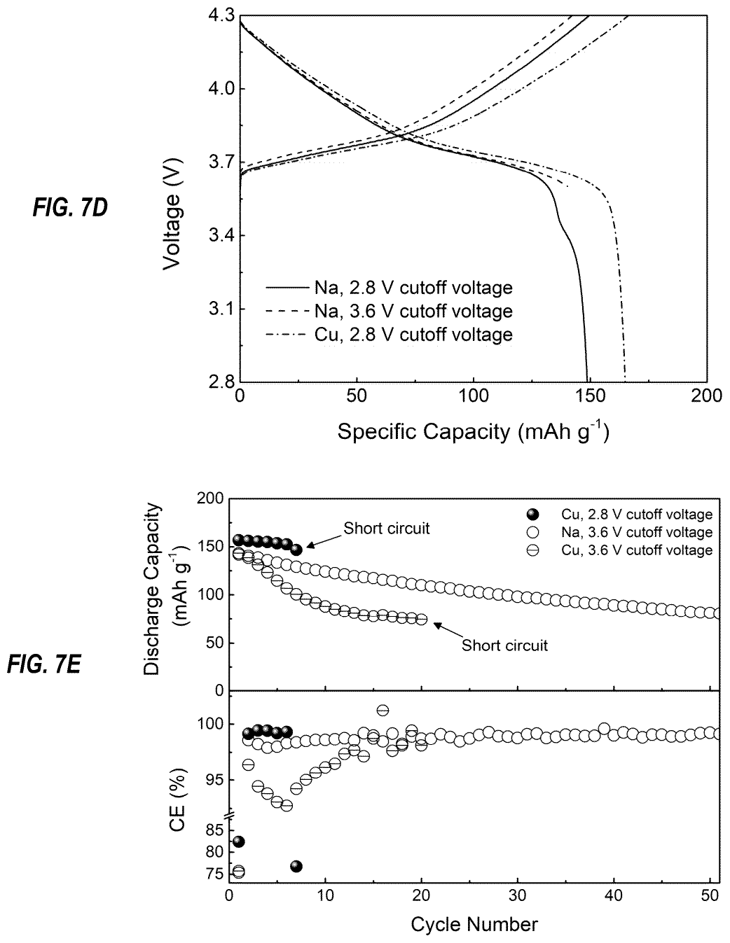

The results in FIGS. 2-12 demonstrate the beneficial effects of the presence of Na within a Li metal composite on improving the interfacial stability during Li stripping. However, the SEM images also suggest that the accumulated Na phase after Li stripping can aid in the uniform and dense Li deposition during the plating step, which is further beneficial for cycling. To better understand this point, electrochemical Li plating directly on pure Na foil was investigated, as shown in FIGS. 7A-B. A Na|LPSC|Li half-cell was built and tested using a current density of 0.25 mA cm⁻² and an areal capacity of 1 mAh cm⁻². Copper (Cu), which is commonly utilized as a current collector in Li-free or anode-free conditions, was also tested under the same conditions as a control experiment. A stack pressure of 3.2 MPa was applied to the cells. FIG. 7B shows the electrochemical cycling results for the Na and Cu foils. These experiments first involved Li plating onto the Na and Cu foils because there was no Li source in the working electrode, as there is in the composites. The Na foil was reversibly cycled over 100 times without degradation, whereas the Cu foil short-circuited during the 2nd Li plating step (FIGS. 7B-C). The CE of the Na foil remained near 99% after the 15th cycle, with an average value of 99.5% over cycles 15-100. This result suggests that the Li redox reaction at the Na-SE interface is highly reversible. Voltage profiles from the very first Li plating step were examined to better understand the Li plating behavior on both foils (bottom of FIG. 7B). In the case of Cu, a voltage spike followed by a plateau appeared, which is likely due to the current constriction from non-conformal contact at the Cu-SE interface and/or the nucleation overpotential. Cu has a yield strength of ˜33 MPa, which is relatively high to form intimate contact at a microscale interface. On the other hand, Na presented a gradual increase in overpotential followed by a plateau with no spike. Given the lower yield strength of Na and the conformal Na-SE contact observed in the SEM images (FIGS. 6A-C), this voltage profile suggests that Li plating on the Na surface is favorable without current constriction effects. This outcome suggests the following points: (1) The accumulated Na phase in the Na/Li composites can improve the stability of the subsequent Li plating steps during the electrochemical cycling of the composite anode; and (2) Na foil can also serve as a Li receiver (i.e., a current collector) in an anode-free cell concept, which is being actively studied as an advanced battery architecture.

To investigate the feasibility of the second point, full cells with Na and Cu foils working electrodes and NMC positive electrodes were assembled and tested at a stack pressure of 4.9 MPa (FIG. 7A). FIG. 7D displays charging and discharging profiles from the 2nd cycle, and both cells were cycled using 0.25 mA cm⁻² from 2.8 V to 4.3 V. Areal capacities of the cells were around 1.5 mAh cm⁻². The voltage profiles from the Na foil were similar with those from the Cu foil. However, the Na foil showed a kink behavior near 3.5 V in the discharge curve, which could be due to a side reaction between the Na foil and the SE. Hence, as shown in the red curves of FIG. 7D, the anode-free cell with Na foil was cycled over a 3.6-4.3 V range in order to avoid the Na side reaction. The cell cycling performances were evaluated up to 50 cycles in FIG. 7E. As control experiments, the anode-free cells with Cu foil were tested at the two different voltage range; 2.8-4.3 V and 3.6-4.3 V (FIG. 7E). The Na foil showed a superior performance up to 50 cycles compared to the Cu foils. The Na foil initially exhibited 142 mAh g⁻¹ of discharge capacity, and it gradually decreased to 81 mAh g⁻¹ at 50 cycles, which is 57% of the initial discharge capacity. The Cu foils showed poor cyclabilities and short circuits within 20 cycles for both voltage conditions. This result implies that the strategical utilization of the Na phase at the SE interface could provide benefits for lithium nucleation and growth compared to conventional current collectors (i.e. Cu foil), and it helps explain why the cycling behavior of the Li/Na composite anodes is quite stable.

### Stack Pressure-Current Density Plot

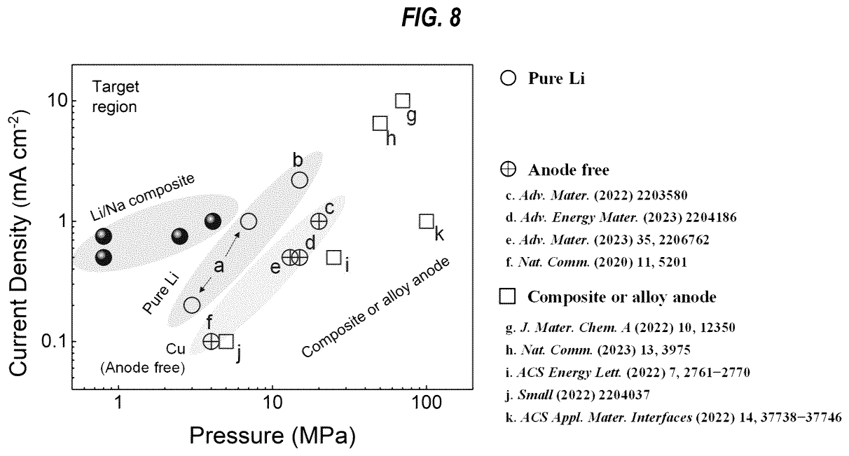

FIG. 8 shows a stack pressure-current density plot that compares the experimental data (the electrochemical cycling results shown in FIG. 5A-D) to other published data. In the graph, the cycling test results with the Li₁In₃ counter electrode (current density of 0.75 mA cm 2 and 2.5 MPa stack pressure, as well as current density of 1 mA cm⁻² and 4.1 MPa stack pressure, FIGS. 5A-B) and the NMC cathode (current densities of 0.5 and 0.75 mA cm⁻² and 0.8 MPa stack pressures, FIGS. 5C-D) are included. Various anode designs have been described in the literature, including composite or alloy types and the anode-free concept, and they all generally require a high stack pressure to cycle the cells at practical current densities (˜1 mA cm⁻²). High stack pressure is also often employed for pure Li metal anodes, along with relatively low current densities, to maintain stable anode-SE interfaces during cell cycling. Our data in the plot in FIG. 8 clearly show the following points: (1) The composite anodes of the present disclosure can have excellent cyclability with relatively high current densities and low stack pressure conditions compared to published reports. (2) The design strategy of combining a mechanically soft filler (for example, Na) with Li metal can improve the interfacial stability of SEs, which has been one of the inherent problems in solid state batteries, along with enhancing cyclability beyond the Li metal anode.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

What is claimed is:

1. An electrode for use with a solid state battery, the electrode comprising a composite metal, the composite metal comprising lithium (Li) and a mechanically soft filler.

2. The electrode of claim 1, wherein the mechanically soft filler comprises sodium (Na).

3. The electrode of claim 2, wherein the sodium is in the form of a plurality of particles dispersed within the lithium.

4. The electrode of claim 1, wherein sodium is present in the electrode at an amount of no more than 25 at % Na.

5. The electrode of claim 5, wherein sodium is present in the electrode at an amount of at least 2.5 at % Na.

6. The electrode of claim 1, wherein the lithium and the mechanically soft filler are immiscible in the temperature range of −20° C. to 60° C.

7. The electrode of claim 1, wherein the lithium and the mechanically soft filler do not form intermetallic compounds in compositions having between 1 atomic % filler and 50 atomic % filler.

8. The electrode of claim 1, wherein a ratio of a yield strength of the mechanically soft filler to a yield strength of the lithium is less than or equal to 20:1.

9. A solid-state battery, comprising:
a cathode;
an anode, the anode comprising a composite metal comprising lithium (Li) and a mechanically soft filler; and
at least one solid electrolyte positioned between the cathode and the anode.

10. The solid-state battery of claim 9, wherein a ratio of a yield strength of the mechanically soft filler to a yield strength of the lithium is less than or equal to 20:1.

11. The solid-state battery of claim 9, wherein the mechanically soft filler comprises sodium (Na).

12. The solid-state battery of claim 10, wherein the sodium is in the form of a plurality of particles dispersed within the lithium.

13. The solid-state batter of claim 12, wherein the particles have an average maximum length of between 1 and 20 microns.

14. The solid-state battery of claim 11, wherein sodium is present in the electrode at an amount of between 2.5 at % and no more than 25 at % Na.

15. The solid-state battery of claim 9, wherein the lithium and the mechanically soft filler are immiscible.

16. The solid-state battery of claim 9, wherein the lithium and the mechanically soft filler are not interatomically bonded to each other.

17. The solid-state battery of claim 9, wherein the anode has a Li stripping capacity of between 1 and 10 mAh cm⁻² at stack pressure ranges of 0-10 MPa.

18. The solid-state battery of claim 9, wherein the anode retains an overpotential of less than 0.1 V in a half cell when stripping up to 11 mAh cm⁻² and the solid-state battery is at stack pressures less than 2.5 MPa.

19. The solid-state battery of claim 9, wherein the solid electrolyte comprises Li₆PS₅Cl (LPSC).

20. The solid-state battery of claim 9, wherein the battery retains at least 80% of its initial charge capacity over 100 cycles at a stack pressure of less than 2.5 MPa.
